(19) United States
(12) Patent Application Publication
(10) Pub. No.: US 2010/0067677 A1
(43) Pub. Date: Mar. 18, 2010

(54) Device for Filtering Out Unwanted Phone Solicitations

(76) Inventor: Apollo Quan Fong, Houston, TX (US)

Correspondence Address: WONG, CABELLO, LUTSCH, RUTHERFORD & BRUCCULERI,;L.L.P., 20333 SH 249 6th Floor, HOUSTON, TX, 77070, US

(21) Appl. No.: 12/210,909

(22) Filed: Sep. 15, 2008

(51) Int. Cl. H04M 1/56

(52) U.S. Cl. 379/142.05

(57) ABSTRACT

A call silencing device filters unsolicited incoming calls to a user's telephone. The call silencer powers up form the telephone and requires no user data input or intervention. An incoming call is silenced if the call is a toll-free number or if the number is not in the buffer and not in the permitted call list or if the number is in the buffer but the caller called back after more than a predetermined amount of time. The incoming call is allowed if the number is in the permitted call list or if the number is in the buffer and the caller called back within a predetermined time. If the call duration is more than a predetermined time, the incoming phone number is stored in the permitted call list. The software program and the permitted call list can be stored in non-volatile memory to maintain data despite power loss.

### BACKGROUND OF THE INVENTION

1. Field of the Invention

The present invention relates generally to public switched telephone networks. Particularly, the present invention relates to filtering out unwanted phone solicitations.

2. Description of the Related Art

A major annoyance with owning a telephone is receiving unwanted phone calls from sources such as telemarketers, salespeople, solicitors, etc.

Certain devices allow the user to screen the calls before answering. Caller-ID allows the user to at least see the name and phone number of the caller before deciding to answer the incoming call. However, certain callers may choose to block their information from being sent to the party being called (e.g., dialing *67 before dialing the number). Therefore, the user has no way of determining whether to answer the call.

Some devices maintain a list of phone numbers that the user wishes to block or allow. If the incoming number matches the number on the list, the device blocks or allows the phone number to ring the user's telephone. However, the caller-ID information sent over the telephone line is not available until after the first ring. Therefore, the user's telephone will ring at least once before the device can take any action. Therefore, even if the device blocks the illegitimate call, the user telephone will ring at least once each time an illegitimate call is received. Furthermore, maintaining the list requires constant user intervention, which may not be convenient for the user.

### SUMMARY OF THE INVENTION

A device (call silencer) for filtering unsolicited phone calls can be communicably connected between the incoming phone loop line and the user's telephone. The call silencer can monitor, detect, and allow or disallow incoming calls. The call silencer circuit draws power form the incoming telephone loop line and does not require additional power supply. Once in operation, the call silencer circuit can silence or allow incoming phone calls without requiring programming, data input, or intervention from the user. The call silencer monitors incoming call patterns and user behavior to decide which of the incoming calls are allowed to ring the user's telephone.

The call silencer circuit comprises a central processing unit (CPU) with communicably connected non-volatile memory, such as flash memory, and random access memory (RAM). The software program and a permitted call list can be stored in the flash memory so that if the call silencer is disconnected from the telephone line, no data is lost. The call silencer also includes a dual-tone multi-frequency decoder for detecting and decoding outgoing phone numbers. Outgoing numbers can be added to the permitted call list.

A ring detector detects an incoming call and communicates an incoming call message to the CPU. The CPU activates a Ring blocking circuit so that the first ring is blocked from ringing the user's telephone. At the end of the first ring, a caller-ID decoder circuit determines the caller-ID information of the incoming call. If the incoming call has a toll-free number, the call is disconnected via a hang-up circuit. If the phone number is not a toll-free number, the CPU stores the number in the buffer and disconnects the phone call. If the same caller calls again within a predetermined time, the incoming call is allowed to ring the user's telephone. Also, if the incoming call has a phone number that matches the permitted call list, the incoming call is allowed to ring the user's telephone.

An off-hook detector circuit detects the ending of a phone call by the user. If the duration of the ended phone call is above a predetermined time, the corresponding incoming phone number is stored in the permitted call list. The CPU stores the updated permitted call list into flash memory to protect the data against power loss.

### BRIEF DESCRIPTION OF THE DRAWINGS

The present invention has other advantages and features which will be more readily apparent from the following detailed description of the invention and the appended claims, when taken in conjunction with the accompanying drawings, in which:

FIG. 1 illustrates a call silencer device in accordance with one or more embodiments of the invention;

FIG. 2 illustrates the block diagram of the call silencer shown in FIG. 1 in accordance with one or more embodiments of the invention;

FIGS. 3a-3e illustrate flowcharts for the operation of the call silencer in accordance with one or more embodiments of the invention.

### DETAILED DESCRIPTION OF THE PREFERRED EMBODIMENTS

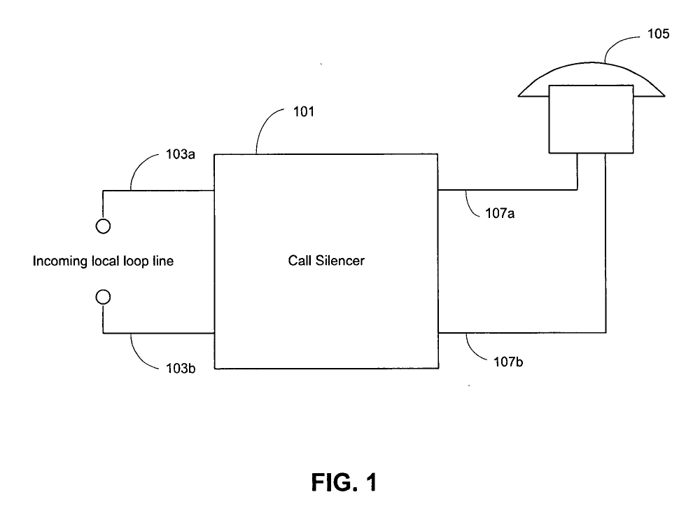

FIG. 1 discloses an exemplary device for filtering out unwanted phone solicitations. The call silencer 101 can be connected between the incoming loop line (103a and 103b) i.e., telephone line, and the user telephone 105. The incoming loop line (103a and 103b) can be connected to the call silencer via a telephone cable and RJ11/RJ14 jacks. Similarly, the call silencer may be connected to the user telephone 105 via a telephone cable and RJ11/RJ14 jacks. Alternatively, the call silencer 101 can be placed within the wall telephone outlet, or even within the user telephone instrument. The user telephone 105 may be replaced with a fax machine, modem, or any communication instrument that connects to a public switched telephone network (PSTN).

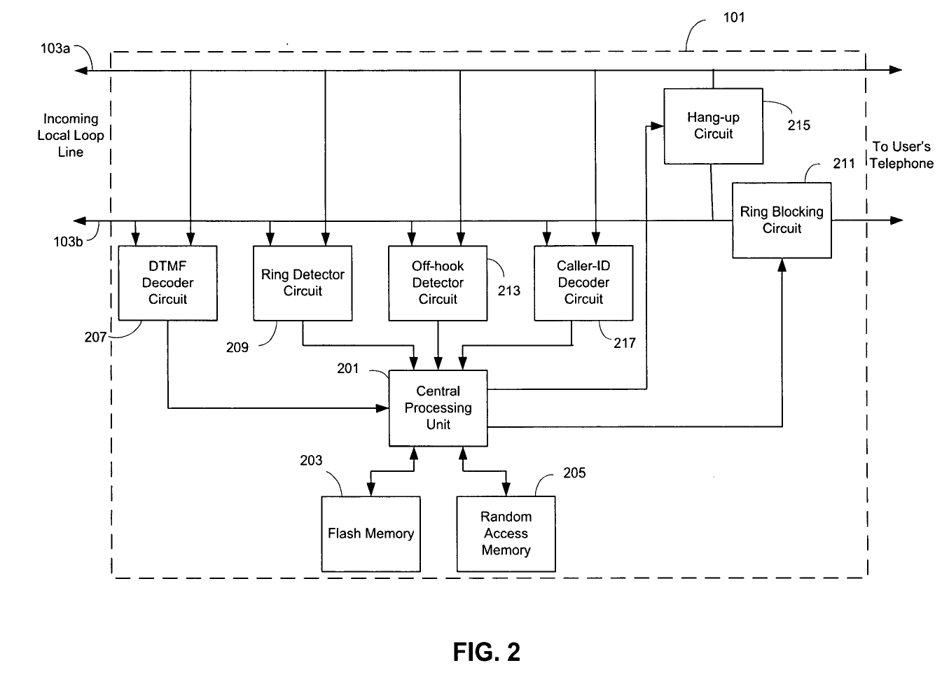

FIG. 2 depicts an exemplary call silencer circuit 101. The call silencer 101 can be connected between the incoming telephone line and the user telephone. The two incoming local loop lines 103a and 103b can carry telephone signals to and from the central telephone office. The Central Processing Unit (CPU) 201 can be a microprocessor, microcontroller, FPGA, ASIC, etc. that can execute instructions and process data stored in the Flash Memory 203 and in the Random Access Memory (RAM) 205. The instructions executed by the CPU 201 can be part of software that can control the operation of the call Silencer 101. The software may include programs for monitoring, silencing, blocking, and allowing calls. The software can also include programs for communicating and controlling various circuits within the Call Silencer 101, accessing data from a database stored in the Flash Memory 203 or RAM 205, etc.

The Flash Memory 203 can store the software and a database that includes a permitted call list. The software includes programs for the operation of the call silencer 101. The permitted call list can include the phone numbers that the call silencer 101 permits to ring the user's telephone. Note that there may be more phone numbers that need to be blocked than the phone numbers that need to be permitted. Therefore it can be more efficient to store a permitted call list as opposed to storing a blocked call list. The Flash Memory 203 serves as a non-volatile memory, the contents of which are not erased upon loss of power supply. The software and the permitted call list can be shadowed into the RAM 205 for execution and access. The transfer of code to the RAM 205 can be performed upon power on. The permit call list may be brought into the RAM 205 upon power on as well. Alternatively, the software program may control the flow of the permitted call list to and from the flash memory 203 during program execution. For example, the program may store the permitted call list back into the flash memory 203 upon changes in the content of the permitted call list stored in the RAM 205. This makes sure that the flash memory 203 has the most updated version of the permitted call list, and upon unexpected power loss, the updated permitted call list can be safely stored in non-volatile memory.

The DTMF detector and decoder 207 detects and decodes dual tone multi-frequency signals originating from the user's telephone. The user typically uses the keypad on his/her telephone instrument initiate a call to another user. Each digit pressed by the user results in a dual tone multi-frequency code being transmitted to the central telephone office. For example, pressing the digit ‘5’ produces two tones at frequencies 770 Hz and 1336 Hz. The DTMF detector and decoder 207 detects and then decodes the outgoing DTMF signals into a series of digits. These digits represent a phone number that the user has dialed. The DTMF decoder 207 can communicate the phone number to the CPU 201, which in turn can store the phone number in a permitted caller's List. The permitted caller list is stored in the Flash Memory 203, and can be updated with each new phone number detected by the CPU 201.

The Ring detector circuit 209 can identify an incoming call's first ring. The ring signal is typically a 20 Hz signal with at least 70V (rms) amplitude. The Ring detector circuit senses for the ring signal and notifies the CPU 201 on the occurrence of the first ring. The CPU 201 then activates the Ring Blocking circuit 211 so that the ring signal is blocked from reaching the user's telephone. The Ring Blocking circuit 211 may comprise a filter that has a stop band designed to be located at the ring signal frequency (e.g., 20 Hz). This filter may be turned on and off by the CPU 201 to block the ring signal from reaching the user's telephone.

The user telephone can be in one of two states (1) Off-hook and (2) On-hook. The Off-hook state signifies that the user has lifted the handset, or pressed the talk button on the telephone. The telephone is in Off-hook state either when the user is initiating a phone call or when the user has answered a received phone call. When the user rests the handset on the cradle or turns off the talk button on the handset, then the telephone is in On-hook state. The user telephone is connected to the central telephone office by a local loop circuit. In the On-hook state, the local loop circuit is open, and therefore no current flows in the local loop circuit. While in the Off-hook state, the local loop circuit is closed resulting in a current flow. The Off-hook detector circuit 213 can detect whether the user telephone is in the Off-hook state or the On-hook state. The status of the user telephone is communicated to the CPU 201.

If the CPU 201 determines that the incoming call is from an unwanted caller, the CPU 201 sends a signal to the Hang-up circuit 215 to answer the call and immediately hang-up on the unwanted caller.

The Caller-ID decoder circuit 217 decodes the called ID information received form the central telephone office. The caller ID information may include the phone number of the caller, the name of the caller, the city and the state the call is being made from, etc. The caller ID information is typically transmitted by the central telephone office after the first ring and before the second ring. The information can be transmitted in the form of a bit stream. For example, the bit stream may be transmitted at 1200 baud with 7 data bits and 1 stop bit. The information may be in “short form,” which includes the data/time of the call and the telephone number of the caller. The information may be transmitted in “long form,” which may additionally include the name and address of the calling phone. The digital information transmitted may be encoded in ASCII characters. The Caller-ID decoder circuit 217 decodes the information within the short-form or long-form transmission and determines the phone number of the caller. This phone number is then communicated to the CPU 201.

The call silencer circuit CS draws power from the incoming telephone loop line for its operation. No additional power source is required. Therefore no additional power cables or power outlets are required for the operation of the call silencer. In addition, because the critical data is stored in non-volatile memory, even if the call silencer is disconnected from the telephone line, no data is lost. The user may simply re-connect the call silencer to the telephone line for the call silencer to resume operation.

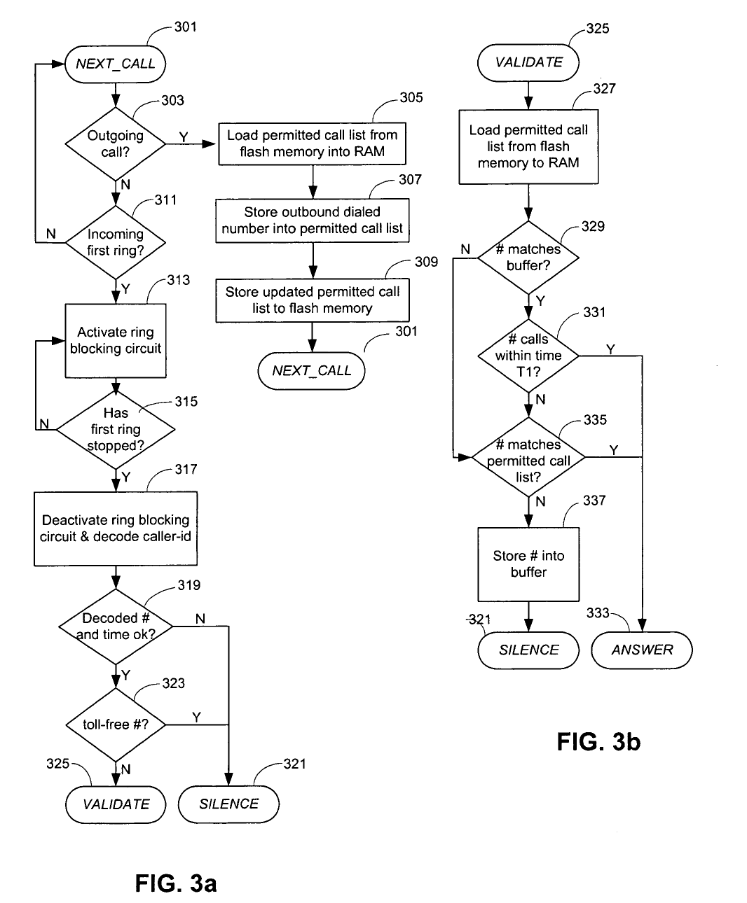

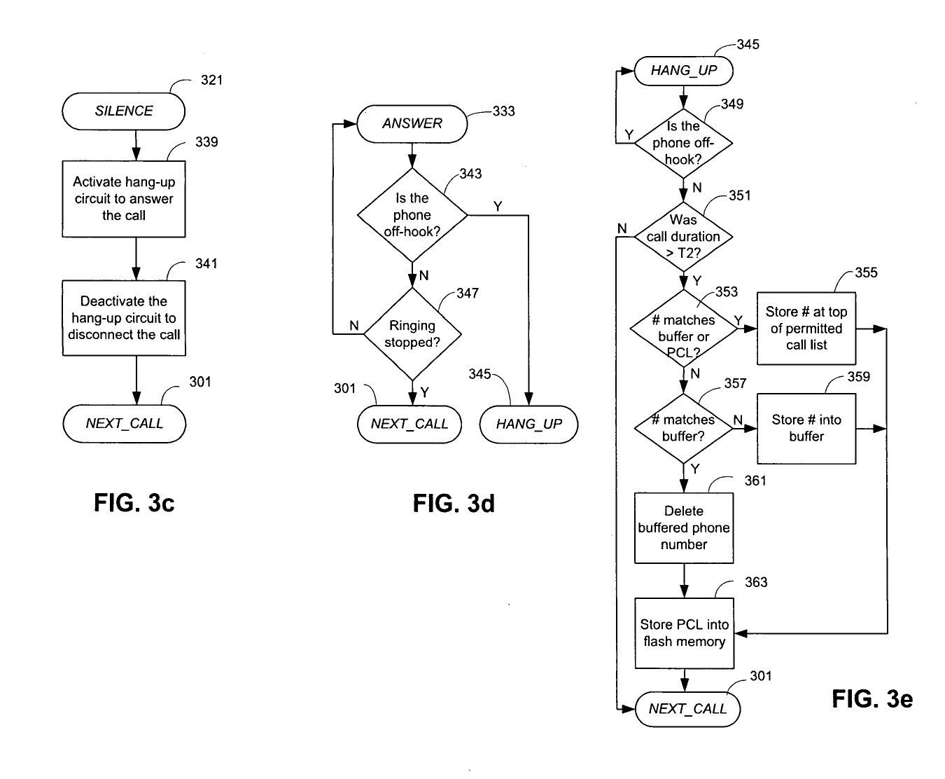

FIGS. 3a-3e disclose exemplary flowcharts depicting the operation of the call silencer. The program waits in step NEXT_CALL (step 301) for an incoming call or an outgoing call. The user can initiate a call by placing the telephone in the off-hook state, and then dialing the desired number. Dialing a phone number generates DTMF tones, which carry the phone number in signal form to the central telephone office. The DTMF detector and decoder (FIG. 2, 207) detects and decodes the DTMF tones being transmitted by the user telephone to the central telephone office (step 303). The call-silencer treats the outgoing numbers as approved numbers because by dialing the number, the user has approved to talk to the person at that number. Therefore the dialed out number can be stored in the permitted call list. If the permitted call list is not in the RAM 205, the CPU 201 loads the permitted call list from the flash memory 203 to the RAM 205 (step 305). The CPU 201 can then store the dialed number to the permitted call list (step 307). Once the permitted call list is updated with the dialed out number, the permitted call list is stored back to the flash memory 203 (step 309). Although not shown in FIG. 3a, if the dialed number is already present in the permitted call list, the CPU 201 can move the number to the top of the permitted call list. Alternately, the permitted call list may include a field, such as “reference count” that may be incremented with each occurrence of the corresponding phone number. The “reference counf” can then serve as a priority indicator such that numbers with low priority may be deleted/replaced by newer numbers in case of list overflow. After the permitted call list is stored in the flash memory 203, the program goes into a wait state NEXT_CALL (step 301) to wait for an incoming or an outgoing call.

When the user is receiving a call, the central telephone office sends a ring signal to the user telephone. The Ring detector circuit (FIG. 2, 209) detects the ring signal and notifies the CPU 201 (step 311). The CPU 201 immediately activates the ring blocking circuit (FIG. 2, 211) to block the ring from reaching the user telephone (step 313). Because at this stage, the identity of the incoming call has not been determined, the call-silencer ensures that the user telephone does not ring.

When the Ring detector circuit (FIG. 2, 209) detects that the first ring has been completed (step 315), the CPU 201 deactivates the Ring blocking circuit 211 (step 317). The central telephone office transmits the caller-ID of the caller after the first ring. By unblocking the ring blocker circuit 211, the call silencer 101 allows the caller ID information to reach the user telephone. If the user telephone has a caller-ID display, the caller-ID information can be seen by the user. As a result, even if the incoming call may be eventually silenced by the call silencer, the user can still receive caller-ID information.

The caller-ID decoder circuit (FIG. 2, 217) decodes the caller-ID information and communicates the caller information to the CPU 201. The content of the caller information may depend upon whether the central telephone office sends caller information in short form or long form. In either case, at least the call time and the caller phone number is included in the caller information. The caller-ID decoder circuit 217 can decode the encoded time stamp and the caller telephone number from ASCII to a format required by the CPU 201 (e.g., into BCD, or base 16). In instances when the caller has deactivated or blocked sending caller information, the caller-ID decoder circuit will either return an error message to the CPU 201 or return a predetermined code. If the time stamp and/or the number of the caller is either received in error, or if the caller has deactivated the sharing of caller information (step 319), the program will silence the incoming call (step 321). If the time stamp and the caller number are received without error, the program determines if the incoming phone number is a toll-free number (step 323). Toll free numbers can include phone numbers with the area codes such as 800, 888, 877, 866, 855, 844, 833, 822, etc. Once the incoming call is determined not belong to the set of numbers that are immediately silenced (e.g., toll free numbers), the program proceeds to validate the number (step 325).

FIG. 3b shows a flowchart that performs validation of the number of the incoming call. The CPU 201 loads the permitted call list from the flash memory 203 (step 327). The CPU 201 compares the phone number of the incoming call with the phone numbers stored in the recent call buffer (RCB) (step 329). Note that in step 329, the CPU 201 may not compare all of the digits of the incoming phone number with the numbers stored in the RCB. For example, the CPU 201 may compare only 5 digits of a 10 digit number to the corresponding 5 digits of the 10 digit numbers stored in the RCB.

Comparing only subset of the total number of digits of the phone number reduces the time required to make a comparison. For example, if it takes time t to compare one digit of the incoming phone number to the corresponding digit of all the numbers stored in the RCB, and the number of digits in a phone number is 10, then the total time required to compare all the digits to the corresponding digits of all the numbers is 10t. However if only m digits of the incoming number are compared, then the time taken to complete the comparison is mt. The downside to comparing only a subset of digits is collision. A collision occurs when the m selected digits of the incoming number match the corresponding digits of a number in the RCB while at least one of the remaining (uncompared) digits is different. A collision may also occur when the m selected digits of the incoming number match the corresponding digits of more than one number stored in the RCB. In either case, the collision results in an incorrect comparison result. The probability of a collision is dependent on the number of digits compared and the probability distribution of each of the digits of the incoming numbers. If it is assumed that the probability distribution is uniform, then the probability of a collision is equal to 1/10^{m}. Therefore, more the number of digits compared (larger the value of m), smaller the probability of the occurrence of a collision. So there is trade-off between faster comparison time by comparing only a subset of digits of the incoming phone number, and the increasing probability of an incorrect comparison due to collision. In practice, however, the probability distribution of each digit of the incoming numbers may not be uniform. For example, most of the user's received calls may be from the same local area-resulting in the first three digits (the area code) of those calls being same. Therefore the actual probability of collision may also depend upon the selected digits' positions within the phone number. The call-silencer may choose less than half the number of digits of the phone number for comparison.

Referring back to FIG. 3b, if the result of the comparison of the incoming number with the numbers stored in the RCB (step 329) is a match, then the program determines the elapsed time between the current and the last time the call from the same number was received. If the elapsed time is less than or equal to T1 (step 331), then the incoming call is legitimate and the program moves to step 333 for allowing the call to go through to the user telephone. The time T1 may be selected as less than 10 minutes, e.g., 4 min. If the time elapsed is greater than T1, then even though the phone number may be in the RCB, the caller did not call back quickly enough to be treated as a legitimate caller. However, the caller may still be listed in the permitted call list stored in the database. The program matches the incoming phone number with all the entries in the permitted call list to determine if the call can be accepted. If the phone number matches an entry in the permitted caller list (step 335), the program moves to answer the phone (step 333). If the phone number does not match any entry in the permitted call list, the caller is deemed to be a first time caller and the phone number is stored in the RCB (step 337). Subsequently, the incoming call is silenced (step 321).

FIG. 3c shows a flowchart for silencing the incoming call after the determination that the incoming phone number is not legitimate, and therefore cannot be permitted to ring the user's telephone. The program activates the hang-up circuit (FIG. 2, 215) so that the incoming call is answered by the call silencer (step 339), and immediately de-activates the hang-up circuit so that the call is disconnected (step 341). At the user's end, the silenced incoming call does not reach the user telephone. At the caller's end, the caller hears only one ring and then a disconnect tone. Note that even though caller hears one ring, the ring is blocked from reaching the user's telephone by the ring blocking circuit (FIG. 2, 211). By disconnecting the call from a phone number that was not legitimate, the user's telephone does not ring. The program subsequently moves to state NEXT_CALL (step 301) to wait for the next incoming or outgoing call.

Therefore, phone calls from illegitimate phone numbers can be silenced by the call silencer 101. A number may be determined to be illegitimate if the phone number is a toll free number or if the phone call comes in without caller-ID information or if the number does not match any entry in the RCB or the permitted call list or if the phone number matches an entry in the RCB but the elapsed time from the last time a call was received from the same phone number is greater than time T1.

The call silencer allows a call to reach the user's telephone only when either the caller's phone number is in the permitted call list in the database, or if the phone number is already stored in the RCB and the elapsed time from the last time a call was received from the same phone number is less than or equal to T1 (FIG. 3b, steps 331 and CDB). FIG. 3d shows a flowchart for answering the call once it has been determined to be legitimate. The program checks whether the phone is in an off-hook state (step 343) i.e., whether the user has lifted the handset to answer the call. If the telephone is in the off-hook state, then the program moves to sub-process HANG-UP step 345. If the user does not lift the handset, or the phone is not in an off-hook state, then the program checks whether the ringing from the incoming call has stopped (step 347). If the ringing has stopped, this indicates that the caller has disconnected the line and the call silencer can wait for the next call to come in or wait for the user to make another call by moving to step NEXT_CALL (step 301).

FIG. 3c shows a flowchart relating to the sub-process HANG_UP. The program checks whether the phone is in the off-hook state (step 349). If the user is currently carrying on a conversation over the phone with a caller, the phone will be in the off-state. Once the user hangs-up, i.e., the phone is no longer in the off-hook state, the program determines the time duration of the last call (step 351). If the time duration of the last call is less than T2, the program moves to step NEXT_CALL (step 301). But if the time duration of the last call is greater or equal to T2, then the program determines whether the number matches any entries either in the RCB or in the permit call list in the database (step 353). If the number matches an entry in the permit call list or is found in the RCB, then that entry is moved to the top of the permit call list (step 355). Note that if the permit call list has reached its upper limit, the entry at the bottom of the permit call list is deleted. Alternatively, an entry from anywhere within the permit call list may be deleted. The deletion may be based on attributes such as the time stamp of the phone number, the number of calls received from the same phone number, etc. If the number does not match any entry in the RCB (step 357), then the number is stored in the RCB (step 359). Because the number found in the RCB is already stored in the database in step 355, the number is deleted from the RCB to free up buffer space (step 361). The updated permit call list is then copied to the flash memory (FIG. 1, 203) in step 363 so that the latest permit call list is available even after a power down. After the permit call list is stored in the flash memory 203, the program moves to the NEXT_CALL state to wait for the next call to come in or for the user to initiate an outgoing call.

As described above the call silencer 101 can automatically learn the phone numbers based on the call behavior of the user. No user intervention is necessary. Because the data is stored in non-volatile memory, the user has the ability to disconnect and re-connect the call silencer 110 at will without being concerned about losing desired operation.

1-2. (canceled)

3. A method for filtering an incoming phone call to a user's telephone, comprising:
receiving the incoming phone call comprising at least a phone number of the incoming phone call and time information related to the incoming phone call; and
allowing the incoming phone call to ring the user's telephone if the phone number of the incoming phone call matches a phone number in a permitted call list,
wherein the permitted call list comprises phone numbers corresponding to those incoming phone calls for which the user's telephone was in an off hook state for more than a predetermined amount of time.

4. The method of claim 3, wherein the incoming phone call is allowed to ring the user's telephone if a subset of digits of the phone number of the incoming phone call match a subset of digits of a phone number in the permitted call list.

5. The method of claim 3, farther comprising storing the permitted call list in a non-volatile memory.

6. The method of claim 3, wherein the permitted call list further comprises phone numbers called from the user's telephone.

7. The method of claim 6, wherein if the phone number called from the user's telephone is already present in the permitted call list, then the phone number is moved to the top of the permitted call list.

8. The method of claim 4, wherein the subset of digits comprises half or less of the total number of digits of the phone number of the incoming phone call.

9. The method of claim 3, further comprising allowing caller information to be received by the user's telephone even if the incoming phone call is not allowed to ring the user's telephone.

10. A method for filtering an incoming phone call to a user's telephone comprising:
receiving the incoming phone call comprising at least a phone number of the incoming phone call and time information related to the incoming phone call;
allowing the incoming phone call to ring the user's telephone if a previous phone call was received within a first predetermined amount of time from the phone number of the incoming phone call; and
allowing the incoming phone call to ring the user's telephone if the phone number of the incoming phone call matches a phone number in a permitted call list.

11. The method of claim 10, further comprising:
storing the phone number of the incoming phone call in the permitted call list if the user's telephone was in an off-hook state for more than a second predetermined amount of time for the incoming phone call.

12. The method of claim 10, further comprising blocking the incoming phone call from ringing the user's telephone if the phone number of the incoming phone call is a toll-free number.

13. The method of claim 10, further comprising storing the permitted call list in a non-volatile memory.

14. The method of claim 10, wherein matching the phone number of the incoming phone call with a phone number in the permitted call list comprises comparing a subset of digits of the phone number of the incoming phone call with a subset of digits of the phone number in the permitted call list.

15. The method of claim 12, wherein the phone number and the time information related to the incoming phone call is allowed to be received by the user's telephone even if the incoming phone call is blocked from ringing the user's telephone.

16. A device for filtering an incoming phone call to a user's telephone comprising:
a ring blocking circuit;
a caller identification detection circuit; and
a central processing unit communicably coupled to the ring blocking circuit and the caller identification detection circuit programmed for:
activating the ring blocking circuit to block a first ring of an incoming phone call;
deactivating the ring blocking circuit to allow a second ring of the incoming phone call to ring the user's telephone if a phone number of the incoming phone call matches a phone number in a permitted call list,
wherein the permitted call list comprises phone numbers corresponding to those incoming phone calls for which the user's telephone was in an off-hook state for more than a predetermined amount of time.

17. The device of claim 16, wherein the ring blocking circuit is deactivated to allow a second ring of the incoming phone call to ring the user's telephone if a subset of digits of the phone number of the incoming phone call match a subset of digits of a phone number in the permitted call list.

18. The device of claim 16, further comprising a non-volatile memory communicably coupled to the central processing unit for storing the permitted call list.

19. The device of claim 16, further comprising an off-hook detector circuit, wherein the phone number of the incoming phone call is stored in the permitted call list if the user's telephone was in the off-hook state for more than a first predetermined amount of time for the incoming phone call.

20. The device of claim 16, farther comprising a hang up circuit communicably coupled to the central processing unit, wherein the central processing unit is programmed for activating the hang up circuit to disconnect the incoming phone call if the phone number of the incoming phone call is a toll-free number.

21. The device of claim 20, wherein the central processing unit is farther programmed for activating the hang up circuit to disconnect the incoming phone call if the phone number or the time information of the incoming phone call is not received.

22. The device of claim 16, wherein the central processing unit is programmed for moving a phone number in the permitted call list to top of the permitted call list if that phone number matches the phone number of the incoming phone call.
